(19) United States
(12) Patent Application Publication
(10) Pub. No.: US 2004/0105379 A1
(43) Pub. Date: Jun. 3, 2004

(54) [EFM DATA DECODING METHOD FOR OPTICAL DISK SYSTEM]

(76) Inventor: SL OUYANG, TAIPEI HSIEN (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,460

(22) Filed: Sep. 30, 2003

(30) Foreign Application Priority Data
Oct. 2, 2002 (TW) 91122705

(51) Int. Cl. G11B 7/00

(52) U.S. Cl. 369/125

(57) ABSTRACT

An eight-to-fourteen modulation (EFM) data decoding method for an optical disk system is provided. The method includes the following steps: extracting 14-bit data from a serial data; looking up a modified EFM decoding table for converting the 14-bit data into a corresponding 8-bit data; and outputting the 8-bit data. The modified EFM decoding table includes transformation entries for converting 14-bit data non-conform to the standard EFM modulation rule into the most probable 8-bit one. This data-accessing reliability is effectively upgraded in the embodiment by specially processing those non-conformable 14-bit data.

### CROSS REFERENCE TO RELATED APPLICATIONS

This application claims the priority benefit of Taiwan application serial no. 91122705, filed on Oct. 2, 2002.

### BACKGROUND OF INVENTION

1. Field of Invention

The present invention relates to a decoding method for reading data from an optical disk. More particularly, the present invention relates to an eight-to-fourteen modulation (EFM) data decoding method for reading data from an optical disk such as a compact disk (CD).

2. Description of Related Art

An eight-to-fourteen modulation (EFM) or a Reed-Soloman modulation procedure is usually performed to interleave data sequence before recording operations so that the data retrieve reliability can be improved under reading operations. Basically, an EFM decoding procedure is required when reading back the stored data from a compact disk. FIG. 1 is a block diagram showing a sequence when recovering accessed data from a compact disk read-only-memory (CD-ROM). As shown in FIG. 1, radio frequency data (RF DATA) derived from a laser sensor is fed to a data-shaping circuit 100, which then generates a digital data signal EFM DATA and a clocking signal EFM CLK. These signals are transferred to an EFM decoding unit 102 that performs decoding operations to these signals and outputs an 8-bit data. A C1 decoding unit 104 receives 32 batches of the 8-bit data (that is, 32×8=256 bits) and decodes them into 28 batches of 8-bit data. Thereafter, an interleaving unit 106 de-interleaves the 28 batches of 8-bit data before transferring them to a C2 decoding unit 108 for further processing.

In a data recording process, a data bit 0 is recorded by burning a pit on a compact disk while a data bit 1 is recorded by leaving a land on the compact disk. The so-called EFM procedure is to transform a 8-bit data into related 14-bit data, while the EFM-processed 14-data is then recorded on the compact disk for storage purpose. Basically, a pit length recorded on the compact disk must last at least 3 EFM CLK cycles but not longer than 11 EFM CLK cycles. In other words, the EFM DATA signal should remain the same within any three EFM CLK cycles; however, the EFM DATA signal must switch its current state (even from high to low or low to high, since the logic 1 indicates the EFM signal must switch the current state in the EFM standard) after 11 EFM CLK cycles (inclusive). Therefore, for a 14-bit data, the number of occurrences of 0 bits between two neighboring 1 bits will be at least two but not larger than 10.

Nowadays, a modern optical disk system usually operates faster than before, for example, an optical disk system usually operates at 40× (forty times the standard speed) or at higher speed for accessing data from a compact disk. On the other hand, any ordinary person skilled in the art knows that a compact disk is easily damaged by scratching. Therefore, the accessed EFM signal waveform may be affected to include data bits non-conformable to the EFM standard due to the aforementioned high operating speed or scratches on the compact disk. The data-accessing reliability may be significantly degraded if the sequential modules directly manipulate the incorrect EFM data without passing proper EFM decoding procedure beforehand. One worse case is that the optical disk system may not recognize the currently accessing compact disk and no data can be read out from the currently accessed one.

### SUMMARY OF INVENTION

Accordingly, one object of the present invention is to provide an eight-to-fourteen modulation (EFM) data decoding method for reading data from a compact disk (CD) and being capable of managing 14-bit data non-conformable to the EFM modulation rule. Therefore, data-accessing reliability may be improved so as to prevent a compact disk from unrecognized by the optical disk system.

To achieve these and other advantages and in accordance with the purpose of the invention, as embodied and broadly described herein, the invention provides an EFM data decoding method for an optical disk system. The method includes the following steps in the first embodiment. First, a serial data read out from an optical disk is obtained, while a 14-bit data, which is ready for EFM decoding, is extracted from the serial data. The 14-bit data is used as an input for looking up a modified EFM decoding table to derive associated 8-bit data. Aside from having normal 14-to-8-bit transformable data, the modified EFM decoding table also includes transformation entries for facilitating any non-conformable 14-bit data to be transferred into the most probable and accurate 8-bit one. Those 14-to-8-bit data transformations that do not conform to the EFM standard includes 14-bit inputs that either have 0 bits less than two between two neighboring 1 bits or have more than ten 0 bits between two neighboring 1 bits.

An alternative EFM data decoding method for an optical disk system including the following steps is disclosed in the second embodiment. First, a serial data is input, while a 14-bit data, which is ready for EFM decoding, is still extracted from the serial data. The 14-bit data is checked to determine if it conforms to the EFM modulation rule. If the 14-bit data is a non-conformable one, the 14-bit data is modified to be the most probable 14-bit one. The modified 14-bit data (or unmodified 14-bit data if it conforms the EFM modulation rule) is used as an input for looking up an EFM decoding table so as to output associated 8-bit data. In the embodiment, a 14-bit data is modified to one having 0 bits between two neighboring 1 bits equal to two if its original 0 bits between two neighboring 1 bits is less than two. Alternatively, if the 0 bits between two neighboring 1 bits in a 14-bit data is more than ten, the non-conformable 14-bit data is modified to one having 0 bits between two neighboring 1 bits exactly equal to ten.

In the embodiments, any non-conformable 14-bit data is replaced by the most probable 14-bit one before actuating the following EFM decoding procedure, or directly outputting the most probable 8-bit data alternatively. Subsequent C1 decoding module may process data with higher reliability so that the disadvantage that a compact disk may be unrecognized by the optical disk system can be effectively avoided.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the sequence of steps for reading data from a CD-ROM.

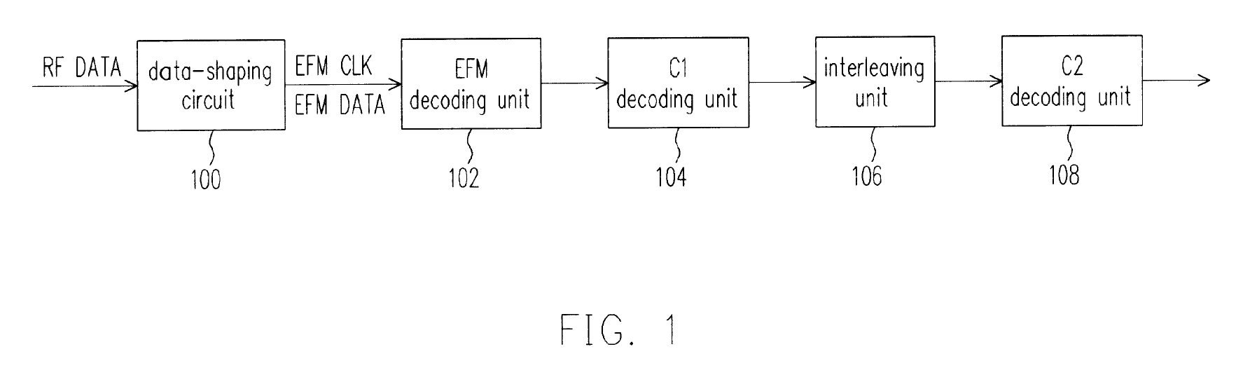

FIG. 2 is a diagram showing example waveforms of 14-bit data waiting for EFM decoding that do not conform to EFM modulation rule.

FIG. 3 is a flow chart showing the steps for performing EFM decoding in an optical disk system according to a first preferred embodiment of this invention.

FIG. 4 is a flow chart showing the steps for performing EFM decoding in an optical system according to a second preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

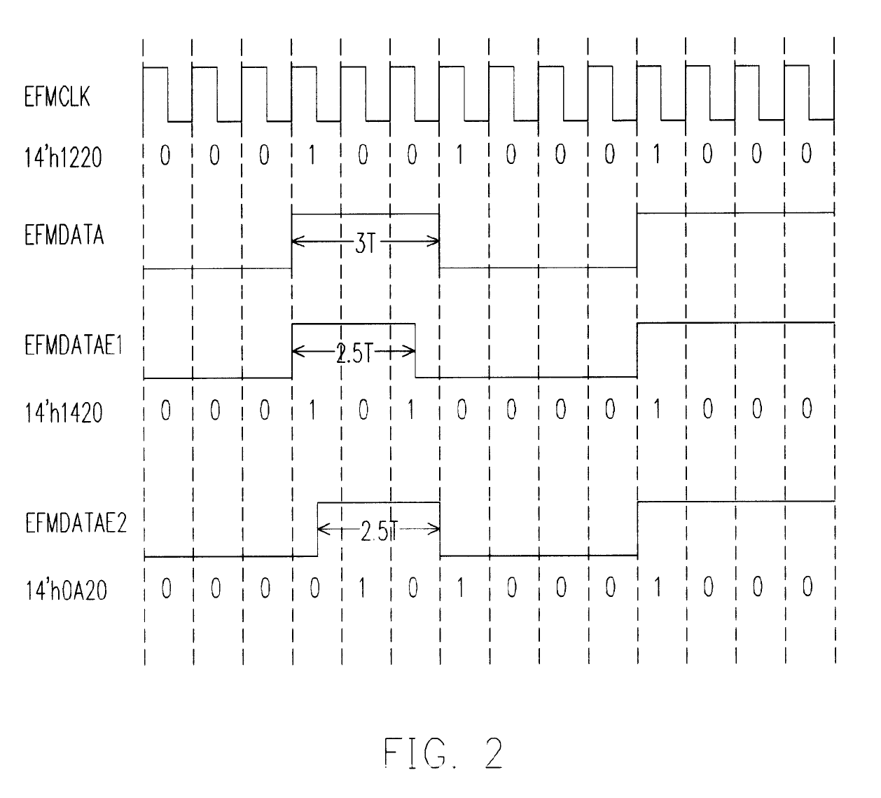

FIG. 2 shows exemplary waveforms of 14-bit data that are waiting for EFM decoding wherein some of them are non-conformable to the EFM standard. The correct waveform of a 14-bit data waiting for EFM decoding is indicated by EFM DATA in FIG. 2, while this 14-bit EFM DATA is represented by 14′h1220. Here, 14′ indicates 14 bits and h represents hexadecimal or 16-based, therefore EFM DATA=0001,0010, 0010, 00b in binary representation.

Normally, the EFM DATA waveform shown in FIG. 2 is obtained under a data read operation. However, a waveform such as EFM DATAE1 or EFM DATAE2 in FIG. 2 may be received because of high operating speed for reading the optical disk or scratches on the accessed compact disk. Obviously, both of the EFM DATAE1 or EFM DATAE2 is non-conformable to the EFM standard since their waveforms remain less than 3 EFM cycles (only 2.5 EFM cycles) for an identical pit. In the examples, the falling edge of the waveform EFM DATAE1 switches earlier while the rising edge of the waveform EFM DATAE2 switches later. These two 14-bit data are represented by: EFM DATAE1=0001,0100,0010,00b=14′h1420; EFM DATAE2=0000,1010,0010,00b=14′h0A20.

These two 14-bit data are obvious non-conformable ones because there is only one 0 bit existed between two neighboring 1 bits, which significantly violates the EFM modulation rule that at least two 0 bits should remain between two neighboring 1 bits. However, if these two 14-bit data EFM DATAE1 and EFM DATAE2 can be modified to be the most probable one (i.e. the EFM DATA in the example) that includes two 0 bits between two neighboring 1 bits, the modified 14-bit data may be transformed to output correct 8-bit data. In another embodiment, a method uses a modified EFM decoding table directly is shown as follows. Firstly, these two 14-bit data EFM DATAE1 or EFM DATAE2 non-conformable to EFM modulation rule is fed as an input to the modified EFM decoding table so that an 8-bit data corresponding to the input one is looked up. With this arrangement, subsequent C1 decoding modules may obtain data having more reliable than before for manipulations. Although subsequent data processing such as ECC (error correction code) and EDC (error detection code) procedures may eliminate errors from the accessed data, the disclosed pre-data-correction procedure performed immediately after analog-to-digital conversion may bring more data reliability than before. Accordingly, any non-conformable data may be replaced by ‘the most probable’ EFM data directly whenever there is data violates the EFM standard, and the data read-out accuracy will be identical to that without any guess at all even if the most probable data derived in the embodiment is still an erroneous one due to incorrect guess.

Similarly, any non-conformable 14-bit data that have more than ten 0 bits between two neighboring 1 bits may be modified into one having exactly ten 0 bits between two neighboring 1 ones, so that the erroneous 14-bit data is replaced by ‘the most probable’ 14-bit data under the disclosed method.

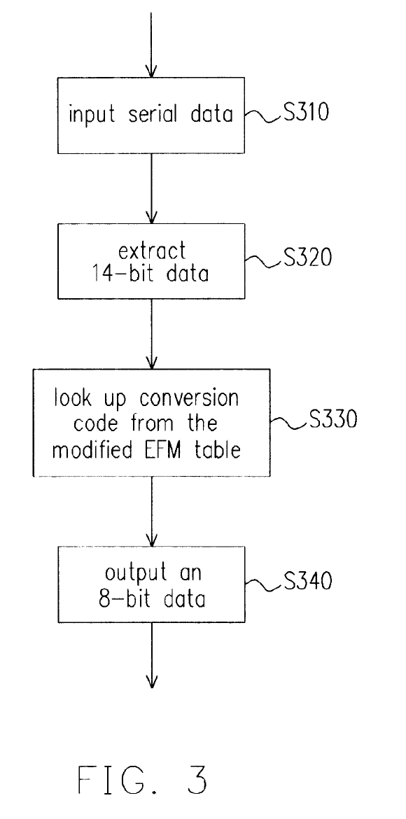

FIG. 3 is a flow chart showing the steps for performing EFM data decoding in an optical disk system according to a first preferred embodiment of this invention. First, in step S310, a serial data such as a radio frequency data (RF DATA) is received by picking up data from an optical disk through a laser sensor. The RF DATA is delivered to a data-shaping circuit to produce digitally serial data. In step S320, a 14-bit data prepared for EFM decoding is extracted from the serial data. For example, the serial data including 33 batches of 14-bit data is accessed from a CD-ROM, while the first one of the 33 batches of 14-bit data contains control code data. In step S330, a modified EFM modulation table is looked up to decode the 14-bit data into an 8-bit one. Finally, in step S340, the decoded 8-bit data is output.

Please note that the modified EFM decoding table also contains transformation entries for decoding those non-conformable 14-bit data into 8-bit one, which indicates that any non-conformable 14-bit data may still be decoded into the most probable 8-bit one. For example, these 14-to-8-bit transformation entries that do not conform to the EFM standard contain 14-bit inputs that either include 0 bits less than two between two neighboring 1 bits, or more than ten 0 bits between two neighboring 1 bits. Table 1 below shows a portion of the modified EFM decoding table, which includes

TABLE 1

| 14-bit data | 8-bit data | 14-bit data | 8-bit data |
|---|---|---|---|
| (14′h1420) | 0 | 14′h1220 | 0 |
| 14′h2100 | 1 | | |
| (14′h2820) | 2 | 14′h2420 | 2 |
| 14′h2220 | 3 | 14′h1100 | 4 |
| 14′h0110 | 5 | 14′h0420 | 6 |
| (14′h0A00) | 7 | 14′h0900 | 7 |
| (14′h1140) | 8 | (14′h1280) | 8 |
| (14′h0A40) | 8 | (14′h1440) | 8 |
| 14′h1240 | 8 | | |
| . . . | . . . | . . . | . . . |

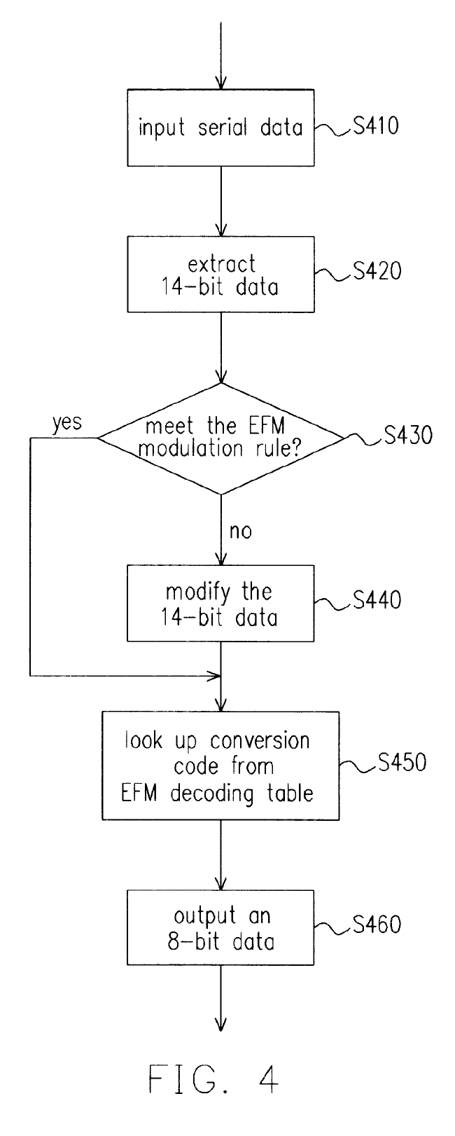

FIG. 4 is a flow chart showing the steps for performing EFM decoding in an optical disk system according to a second preferred embodiment of this invention. First, a serial data is input in step S410. In step S420, a 14-bit data prepared for EFM decoding is extracted from the serial data. In step S430, the 14-bit data is checked to determine if it follows the EFM modulation rule. If the 14-bit data is found to be a non-conformable one in step S440, the 14-bit data is modified to be the most probable 14-bit one. Next, in step S450, an EFM decoding table is consulted to find an 8-bit data corresponding to the 14-bit data. Finally, in step S460, the 8-bit data is output.

This invention provides a special EFM data decoding method that operates according to the following arrangements. If the 14-bit data does not conform to the standard EFM modulation rule, the 14-bit data is first modified to be the most probable 14-bit one before a table look-up operation. For example, if the number of 0 bits between two neighboring 1 bits in the 14-bit data is less than two, the 14-bit data is modified to one having exactly two 0 bits between two neighboring 1 bits. Alternatively, if the number of 0 bits between two neighboring 1 bits in the 14-bit data is more than ten, the 14-bit data is modified to one having exactly ten 0 bits between two neighboring 1 bits.

Subsequent C1 decoding module may obtain more reliable data for manipulations based on the operation of directly outputting the most probable 8-bit data or the replacement of the non-conformable 14-bit data with the most probable 14-bit data before an EFM decoding operation disclosed in the embodiments. Therefore, the disadvantage that an optical disk may be unrecognized is overcome since the disclosed methods provide efficient approaches to derive most likely transformation data.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A data decoding method for an optical disk system, comprising the steps of:
extracting a first batch of data encoded in a first bit format from a serial data;
looking up a modified decoding table to convert the first batch of data into a second batch of data encoded in a second bit format, wherein the modified decoding table includes a data conversion for a first batch of data thatdoes not conform to a standard modulation rule; and
outputting the second batch of data.

2. The data decoding method of claim 1 wherein the first bit format is encoded in 14 bits and the second bit format is encoded in 8 bits.

3. The data decoding method of claim 2 wherein the first batch of data that does not conform to the standard modulation rule has less than two first type of logic bits between two neighboring second type of logic bits within the first batch of data.

4. The data decoding method of claim 2 wherein the first batch of data that does not conform to the standard modulation rule has more than ten first type of logic bits between two neighboring second type of logic bits within the first batch of data.

5. The data decoding method of claim 1 wherein the optical system is able to read data from a compact disk read-only-memory (CD-ROM).

6. The data decoding method of claim 1 wherein the standard modulation rule is an eight-to-fourteen modulation (EFM) and the standard modulation rule follows an EFM standard.

7. The data decoding method of claim 6 wherein the modified decoding table comprises transformation entries conformable to the EFM standard.

8. A data decoding method for an optical disk system, comprising the steps of:
extracting a first batch of data encoded in a first bit format from a serial data;
modifying the first batch of data to conform to a standard modulation rule if the first batch of data does not conform to the standard modulation rule;
converting the first batch of data into a second batch of data encoded in a second bit format by consulting a decoding table; and
outputting the second batch of data.

9. The data decoding method of claim 8 wherein the first bit format is encoded in 14 bits and the second bit format is encoded in 8 bits.

10. The data decoding method of claim 9 wherein the first batch of data that does not conform to the standard modulation rule has less than two first type of logic bits between two neighboring second type of logic bits within the first batch of data.

11. The decoding method of claim 9 wherein the step of modifying the first batch of data includes setting the number of first type of logic bits between two neighboring second type of logic bits within the first batch of data to two.

12. The data decoding method of claim 9 wherein the first batch of data that does not conform to the standard modulation rule has more than ten first type of logic bits between two neighboring second type of logic bits within the first batch of data.

13. The decoding method of claim 9, wherein the step of modifying the original first batch of data includes setting the number of first type of logic bits between two neighboring second type of logic bits within the first batch of data to ten.

14. The data decoding method of claim 8, wherein the optical system is able to read data from a compact disk read-only-memory (CD-ROM).

15. The data decoding method of claim 8 wherein the standard modulation rule is an eight-to-fourteen modulation (EFM) and the standard modulation rule follows an EFM standard.

16. The data decoding method of claim 15 wherein the decoding table comprises transformation entries conformable to the EFM standard.
